(19) United States
(12) Patent Application Publication
(10) Pub. No.: US 2018/0004924 A1
(43) Pub. Date: Jan. 4, 2018

(54) SYSTEMS AND METHODS FOR DETECTING BIOMETRIC TEMPLATE AGING

(71) Applicant: Synaptics Incorporated, San Jose, CA (US)

(72) Inventor: Kinh Tieu, Sunnyvale, CA (US)

(21) Appl. No.: 15/199,749

(22) Filed: Jun. 30, 2016

(51) Int. Cl. G06F 21/32; G06F 21/62

(52) U.S. Cl. CPC G06F 21/32; G06F 21/6218

(57) ABSTRACT

Systems and methods for biometric authentication are disclosed. A system comprises a biometric sensor and a processing system configured to: receive, from the biometric sensor, data corresponding to a first attempt to validate an identity of a user; determine that a first score associated with the first attempt satisfies an authentication condition associated with a first biometric template; receive, from the biometric sensor, data corresponding to at least one subsequent attempt to validate the identity of the user, wherein the at least one subsequent attempt is received after the first attempt; determine that a second score associated with the at least one subsequent attempt satisfies the authentication condition; identify, based on the first score and the second score, a trend in the scores associated with attempts that satisfy the authentication condition; and, in response to identifying the trend, request the user to enroll a second biometric template.

### FIELD

This disclosure relates generally to the field of biometrics and, more specifically, to systems and methods for detecting biometric template aging.

### BACKGROUND

Since its inception, biometric sensing technology has revolutionized identification and authentication processes. The ability to capture and store biometric data in a digital file of minimal size has yielded immense benefits in fields such as law enforcement, forensics, and information security.

However, the widespread adoption of biometric sensing technology in a broad range of applications has faced a number of obstacles. When biometric sensing technology is used for authentication (for example, for unlocking a mobile device), the process is inherently noisy or imperfect. Also, biometric traits may change over time, for example, as user's facial features or other physiological characteristics change as they get older. In the case of a fingerprint, for example, new creases or cuts may develop on the finger. These changes can be large enough to reduce scores in biometric verification attempts such that the frequency of rejections increases, resulting in frustration for the user. This problem is known as “template aging.”

### SUMMARY

One embodiment provides a device for biometric authentication. The device comprises a biometric sensor and a processing system. The processing system is configured to: receive, from the biometric sensor, data corresponding to a first attempt to validate an identity of a user; determine that a first score associated with the first attempt satisfies an authentication condition associated with a first biometric template; receive, from the biometric sensor, data corresponding to at least one subsequent attempt to validate the identity of the user, wherein the at least one subsequent attempt is received after the first attempt; determine that a second score associated with the at least one subsequent attempt satisfies the authentication condition; identify, based on the first score and the second score, a trend in the scores associated with attempts that satisfy the authentication condition; and, in response to identifying the trend, request the user to enroll a second biometric template.

Other embodiments provide a method and non-transitory computer-readable storage medium storing instructions that, when executed by a processor, causes a computing device to authenticate a user, by performing steps comprising: receiving, from a biometric sensor, data corresponding to a first attempt to validate an identity of the user; determining that a first score associated with the first attempt satisfies an authentication condition associated with a first biometric template; receiving, from the biometric sensor, data corresponding to at least one subsequent attempt to validate the identity of the user, wherein the at least one subsequent attempt is received after the first attempt; determining that a second score associated with the at least one subsequent attempt satisfies the authentication condition; identifying, based on the first score and the second score, a trend in the scores associated with attempts that satisfy the authentication condition; and, in response to identifying the trend, requesting the user to enroll a second biometric template.

### BRIEF DESCRIPTION OF THE DRAWINGS

FIG. 1 is a block diagram of an example electronic system that includes an input device and a processing system, according to an embodiment of the disclosure.

FIG. 2 is a block diagram of a system for detecting template aging and updating a biometric template, according to one embodiment of the disclosure.

FIG. 3A is a chart illustrating template aging, according to one embodiment of the disclosure.

FIG. 3B is a chart illustrating detection of template aging, according to one embodiment of the disclosure.

FIG. 4 is a flow diagram of method steps for authenticating a user, according to one embodiment of the disclosure.

### DETAILED DESCRIPTION

The following detailed description is merely exemplary in nature and is not intended to limit the disclosure or the application and uses of the disclosure. Furthermore, there is no intention to be bound by any expressed or implied theory presented in the preceding technical field, background, brief summary or the following detailed description.

Embodiments of the disclosure are directed to devices and methods for detecting problems in biometric authentication related to template aging, where authentication performance decreases over time. Some solutions to template aging require re-enrollment after a pre-specified amount of time (e.g., re-enroll after six months) or to require re-enrollment when the frequency of failed user verifications exceeds a specific level. However, these solutions can be disruptive to the user. Systems and methods described herein can model the history of authentication attempts as a time series to detect trends such as, for example, decreasing verification scores. Authentication history information can be used by a processing system to predict when authentication performance is expected to decrease, e.g., because of issues such as template aging. In some embodiments, the predictions can be used to inform the user to re-enroll. In other embodiments, the system can automatically re-enroll the user with a new template based on the authentication history information. In one embodiment, re-enrolling the user comprises modifying or updating the existing template. In other embodiments, re-enrolling the user comprises enrolling a new template and replacing the existing template with the newly enrolled template. In still further embodiments, re-enrolling the user comprises adding a newly enrolled template while still keeping the prior template or templates. The authentication history information can also be used to detect other issues such as sensor problems, which could correspond to a sudden drop in verification scores.

Some embodiments of the disclosure model the authentication history information to predict that problems, such as template aging, are occurring well in advance of a high rejection rate for the user. This makes the system easier to use and less frustrating to the user. For example, the system may detect that, although the user has consistently been able to authenticate, the scores are decreasing. Thus, the user may be asked to re-enroll a new template before the scores decrease to the point where more authentication attempts will fail on a consistent basis.

According to various embodiments, biometric authentication, such as unlocking a mobile phone using a fingerprint, involves two processes: enrollment and verification. Ideally, enrollment occurs only once, where the user provides a sample of the biometric to the system, such as touching her finger on the fingerprint sensor. The processed and stored enrollment sample is called a template. Subsequently, verification occurs each time the user attempts to authenticate using her finger. In some embodiments, each verification attempt involves comparing a new sample of the biometric to one or more stored templates, and producing a score based on a degree of correspondence between the new sample and the stored template(s), which is compared to a threshold to make a final decision whether to accept or reject the authentication attempt. In other embodiments, one or more verification criteria should be satisfied in order to authenticate a user.

One issue with conventional authentication techniques, as described above, is that the authentication system assumes that biometrics used to authenticate are static, rather than time-dependent. Embodiments of the disclosure model biometric authentication as a time-dependent process by storing the history of authentication attempts and using the history to detect issues, such as template aging. For example, by tracking the evolution of scores in successful verification attempts, a decreasing trend can be detected, indicating potential template aging. This information can then be used by the system, for example, to inform the user that re-enrollment may be beneficial for continued high verification performance. Moreover, other events in the temporal history of successful verification scores, such as a sudden drop, can hint to other issues such as problems with the sensor.

In one implementation, detecting trends in the verification score history comprises modeling the time series with a simple trend model, such as a linear trend line with time, where a negative slope indicates template aging. More sophisticated time series models with multiple components can handle other events, such as sudden drops in scores, as described in greater detail below.

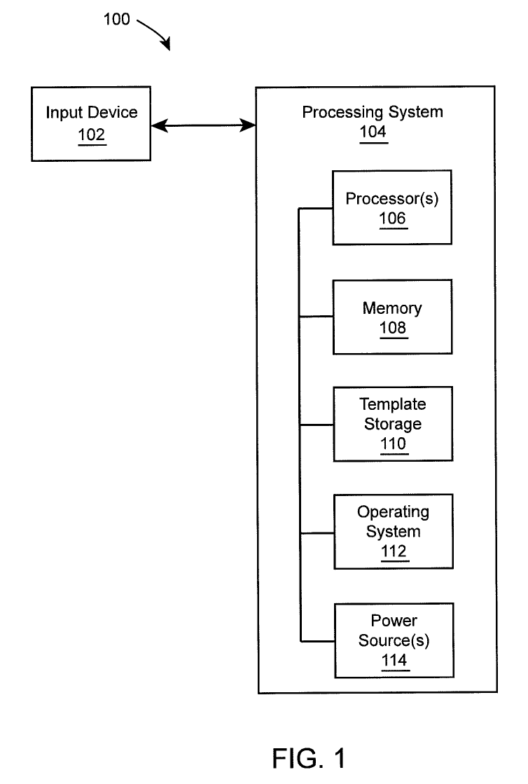

Turning to the figures, FIG. 1 is a block diagram of an example electronic system 100 that includes an input device 102 (e.g., a sensor) and a processing system 104, according to an embodiment of the disclosure. As used in this document, the term “electronic system” (or “electronic device”) broadly refers to any system capable of electronically processing information. Some non-limiting examples of electronic systems include personal computers of all sizes and shapes, such as desktop computers, laptop computers, netbook computers, tablets, web browsers, e-book readers, and personal digital assistants (PDAs). Additional example electronic devices include composite input devices, such as physical keyboards and separate joysticks or key switches. Further example electronic systems include peripherals, such as data input devices (including remote controls and mice) and data output devices (including display screens and printers). Other examples include remote terminals, kiosks, and video game machines (e.g., video game consoles, portable gaming devices, and the like). Other examples include communication devices (including cellular phones, such as smart phones), and media devices (including recorders, editors, and players such as televisions, set-top boxes, music players, digital photo frames, and digital cameras). Additionally, the electronic device 100 could be a host or a slave to the input device 102.

Input device 102 can be implemented as a physical part of the electronic device 100 or can be physically separate from the electronic device 100. In various embodiments, the input device 102 may communicate with parts of the electronic device 100 using any one or more of the following: buses, networks, and other wired or wireless interconnections. Examples include I²C, SPI, PS/2, Universal Serial Bus (USB), Bluetooth®, RF, and IRDA.

According to various embodiments, input device 102 is a biometric sensor that utilizes one or more various electronic sensing methods, techniques and devices to capture an image of a biometric pattern of a user. For example, in certain embodiments the input device 102 is a fingerprint sensor that uses capacitive sensing, optical sensing, ultrasonic sensing, or another sensing technology to capture an image of a fingerprint. In other embodiments, the input device 102 is an iris scanner configured to capture an image of an iris pattern of a user, or a retina scanner configured to capture an image of a retina pattern of a user. In yet further embodiments, the input device 102 is a biometric sensor configured to capture some other biometric pattern of the user, such as a camera that captures an image of a face of a user for facial recognition.

In other embodiments, the input device 102 is not used to capture a biometric image. For example, in a “lossy” password authentication scheme, the input device 102 could be a keyboard input. In still further embodiments, the input device 102 is a biometric sensor configured to capture behavioral biometrics, such as gestures. As an example, the input device 102 could be a proximity sensor configured to capture a gesture attempt that is matched to a stored gesture for authentication, such as a touch pad or touch screen configured to capture a 2D gesture, or a structured illumination sensor or ultrasonic sensor configured to capture 3D user gestures.

Turning now to the processing system 104 of FIG. 1, basic functional components of the electronic device 100 utilized during capturing, storing, and validating an authentication attempt are illustrated. The processing system 104 includes a processor(s) 106, a memory 108, a template storage 110, an operating system (OS) 112, and a power source(s) 114. Each of the processor(s) 106, the memory 108, the template storage 110, the operating system 112 and power source 114 are interconnected physically, communicatively, and/or operatively for inter-component communications.

As illustrated, processor(s) 106 are configured to implement functionality and/or process instructions for execution within electronic device 100 and the processing system 104. For example, processor 106 executes instructions stored in memory 108 or instructions stored on template storage 110 to determine whether an authentication attempt is successful or unsuccessful. Memory 108, which may be a non-transitory, computer-readable storage medium, is configured to store information within electronic device 100 during operation. In some embodiments, memory 108 includes a temporary memory, an area for information not to be maintained when the electronic device 100 is turned off. Examples of such temporary memory include volatile memories such as random access memories (RAM), dynamic random access memories (DRAM), and static random access memories (SRAM). Memory 108 also maintains program instructions for execution by the processor 106.

Template storage 110 comprises one or more non-transitory computer-readable storage media. In the context of a fingerprint sensor, the template storage 110 is generally configured to store one or more enrollment views for fingerprint images for a user's fingerprint or other enrollment information. The template storage 110 may further be configured for long-term storage of information. In some examples, the template storage 110 includes non-volatile storage elements. Non-limiting examples of non-volatile storage elements include magnetic hard discs, optical discs, floppy discs, flash memories, or forms of electrically programmable memories (EPROM) or electrically erasable and programmable (EEPROM) memories, among others.

The processing system 104 also hosts an operating system (OS) 112. The operating system 112 controls operations of the components of the processing system 104. For example, the operating system 112 facilitates the interaction of the processor(s) 106, memory 108, and template storage 110.

The processing system 104 includes one or more power sources 114 to provide power to the electronic device 100. Non-limiting examples of power source 114 include single-use power sources, rechargeable power sources, and/or power sources developed from nickel-cadmium, lithium-ion, or other suitable material.

While many embodiments of the disclosure are described in the context of a fully functioning apparatus, the mechanisms of the present disclosure are capable of being distributed as a program product (e.g., software) in a variety of forms. For example, the mechanisms of the present disclosure may be implemented and distributed as a software program on information bearing media that are readable by electronic processors (e.g., non-transitory computer-readable and/or recordable/writable information bearing media readable by the processing system 104). Additionally, the embodiments of the present disclosure apply equally regardless of the particular type of medium used to carry out the distribution. Examples of non-transitory, electronically readable media include various discs, memory sticks, memory cards, memory modules, and the like. Electronically readable media may be based on flash, optical, magnetic, holographic, or any other storage technology.

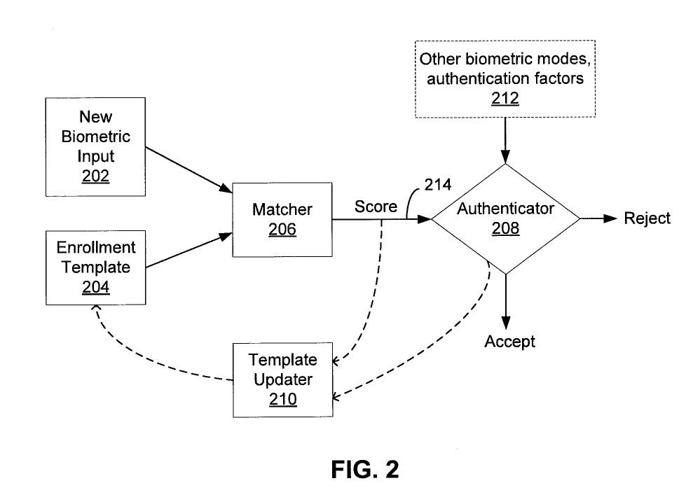

FIG. 2 is a block diagram of a system for detecting template aging and updating a biometric template, according to one embodiment of the disclosure. As shown in FIG. 2, a new biometric input 202 is received. The biometric input 202 may be captured by the input device 102 in FIG. 1. The biometric input 202 is received by a matcher 206. In one embodiment, the matcher 206 may be implemented in hardware, for example as part of the processor(s) 106. In another embodiment, the matcher 206 may be implemented as software, for example as instructions stored in memory 108 and executed by the processor(s) 106.

The matcher 206 also receives one or more enrollment templates 204. For example, the one or more enrollment templates may be stored in template storage 110 in FIG. 1.

The matcher 206 is configured to compute a score 214 based on a degree of correspondence between the new biometric input 202 and the one or more enrollment templates 204. The matcher 206 transmits the score 214 to an authenticator 208. In one embodiment, the authenticator 208 may be implemented in hardware, for example as part of the processor(s) 106. In another embodiment, the authenticator 208 may be implemented as software, for example as instructions stored in memory 108 and executed by the processor(s) 106. In some embodiments, the matcher 206 and the authenticator 208 are conceptually coupled as one logical unit. In other embodiments, the matcher 206 and the authenticator 208 are conceptually de-coupled as two separate logical units, as shown in FIG. 2.

The authenticator 208 is configured to make an authentication decision based at least in part on the score 214. The authentication decision can be to accept or reject an authentication attempt corresponding to the new biometric input 202.

In one embodiment, the authenticator 208 compares the score 214 to a threshold and the accept/reject authentication decision is made based on whether the score 214 satisfies the threshold.

In another embodiment, the authenticator 208 fuses the score 214 with other biometric authentication scores from other authentication modes to make the accept/reject authentication decision. For example, a multi-modal system may analyze both face detection and fingerprint detection. The multi-modal system determines a fingerprint matching score by comparing a new fingerprint image to a fingerprint template and determines a face matching score based on comparing the new input face image to a face template. The face and fingerprint scores are then normalized and fused into a single multi-modal matching score. The authenticator 208 makes an authentication decision based on whether the fused score is above threshold.

In yet another embodiment, a multi-modal system may analyze two or more different biometrics (e.g., face and fingerprint) and the authenticator 208 makes the accept/reject authentication decision when a face matching score or a fingerprint matching score is above a respective threshold. The template updater tracks the face matching score for successful authentication attempts and initiates re-enroll of face template when the face score trends downward. Many of the face matching scores for these are actually below threshold and non-matches, but the authentications are successful due to the OR combination, including the authentication attempt that is just before re-enroll is triggered

In still another embodiment, the authenticator 208 compares the score 214 to a threshold to make a match/non-match authentication decision, and the match/non-match authentication decision is fused with other decisions to make the authentication decision. For example, as shown in block 212 in FIG. 2, other biometrics or other authentication factors can be received by the authenticator 208. An example of another authentication factor includes a password. For example, the authenticator 208 first determines whether the score 214 satisfies a threshold, and then determines whether the password matches a stored password. In some embodiments, the authenticator 208 may accept the authentication attempt, even if the score 214 for the new biometric input 202 does not satisfy the threshold if other biometric modes satisfy their corresponding threshold or match their corresponding template or stored information.

As also shown in FIG. 2, the score 214 is transmitted to a template updater 210. The results of the authentication decision of the authenticator 208 may also be transmitted to the template updater 210. In one embodiment, the template updater 210 may be implemented in hardware, for example as part of the processor(s) 106. In another embodiment, the template updater 210 may be implemented as software, for example as instructions stored in memory 108 and executed by the processor(s) 106. In some embodiments, the template updater 210 is conceptually coupled with the matcher 206 and/or the authenticator 208 as one logical unit. In other embodiments, the template updater 210 is conceptually de-coupled from the matcher 206 and the authenticator 208, as shown in FIG. 2.

The template updater 210 looks for trends in the score 214 and/or authentication decisions, and based on the trends, may request the user to update or re-enroll the enrollment template, as described herein. For example, when the template updater 210 determines that a fingerprint matching score is trending downwards, the template updater 210 may request the user to update or re-enroll the enrollment template. In embodiments where the authenticator 208 analyzes other biometric scores from other authentication modes (e.g., face, gesture, passwords, etc.), the template updater 210 can track the other biometric matching scores (e.g., face matching scores) for successful authentication attempts and initiates re-enroll of the other biometric template(s) when the other biometric matching scores trend downward. In the embodiments, in which the authenticator 208 analyzes fused scores, the template updater 210 may be configured to detect downward trends in individual matching scores, but does not analyze the fused score.

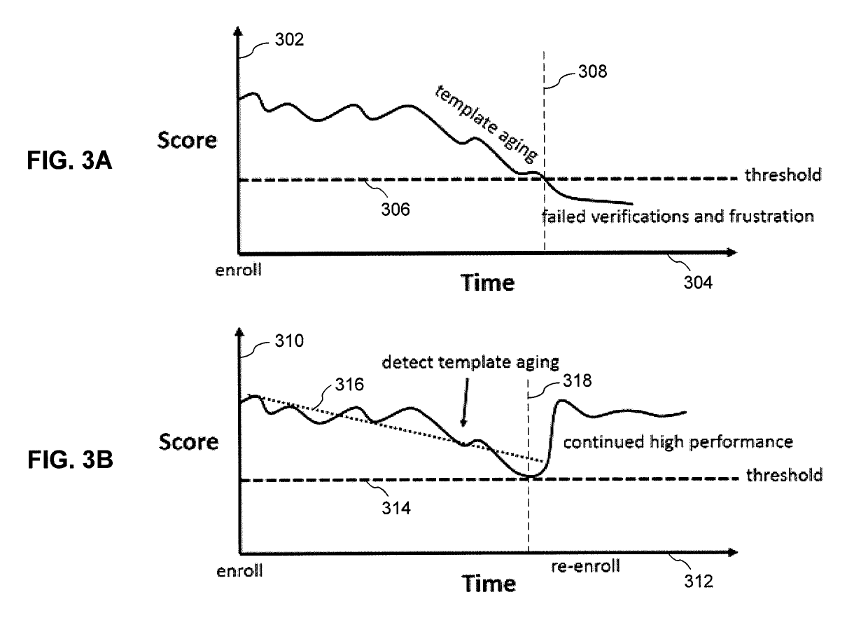

FIG. 3A is a chart illustrating template aging, according to one embodiment of the disclosure. In the example shown in FIG. 3A, a user first enrolls a biometric template. Each time that the user attempts to authenticate, the authentication attempt is assigned a score 302. In some typical authentication schemes, an authentication attempt is compared to an enrollment template and given a score corresponding to how closely the authentication attempt matches the template. In some embodiments, if the score 302 satisfies a threshold 306, the authentication attempt is deemed to be successful and authentication is achieved. If the score 302 does not satisfy the threshold 306, the authentication attempt is unsuccessful and authentication is denied.

In some embodiments, the value of the threshold 306 may correspond to a certain false accept rate (FAR). For example, an industry standard for security of authentication schemes can set a false accept rate (FAR) to be on the order of 1 in 10,000 attempts to one in 1 in 100,000 attempts.

As shown in FIG. 3A, as time 304 increases, the values of the scores 302 begin to decrease. This is referred to as template aging. Eventually, as shown at time 308, the scores 302 decrease such that a large majority of authentication attempts fall below the threshold 306. This results in many failed verification attempts and frustration to the user. The user may then be asked to re-enroll the biometric template to hopefully achieve better results, e.g., to achieve fewer false rejections.

FIG. 3B is a chart illustrating detection of template aging, according to one embodiment of the disclosure. In the example shown in FIG. 3B, a user first enrolls a biometric template. Each time that the user attempts to authenticate, the authentication attempt is assigned a score 310. If the score 310 satisfies a threshold 314, the authentication attempt is deemed to be successful and authentication is achieved. If the score 310 does not satisfy the threshold 314, the authentication attempt is unsuccessful and authentication is denied.

As shown in FIG. 3B, as time 312 increases, the values of the scores 310 begin to decrease, i.e., template aging is occurring. According to embodiments of the disclosure, a processing system, such as template updater 210 in FIG. 2, may detect that template aging is occurring based on storing historical values of the authentication scores and analyzing the values of the authentication scores over time. For example, in one embodiment, the processing system may assign a trend line 316 to the scores. According to various embodiments, a trend line is a straight or curved line in a chart that indicates the general pattern or direction of time series data (i.e., information in sequence over time). The trend line may be drawn visually by connecting the actual data points or, more frequently, by using statistical techniques such as exponential smoothing or moving averages.

In the example in FIG. 3B, the processing system may detect that the trend line 316 has a negative slope, which suggests template aging may be occurring. In one embodiment, based on detecting that the trend line 316 has a negative slope, at time 318, the processing system may request to the user to re-enroll a new template. In another embodiment, the trend line 316 can be compared to some predetermined condition that indicates template aging, such as checking whether the slope of the trend line 316 is below a slope threshold. As shown, after re-enrollment, the scores 310 increase dramatically and continued high performance is achieved, i.e., continued successful authentication attempts. In one embodiment, the processing system requests the user to re-enroll prior to the scores decreasing to the point where many authentication attempts will fail on a consistent basis (i.e., many scores that fall below the threshold 314).

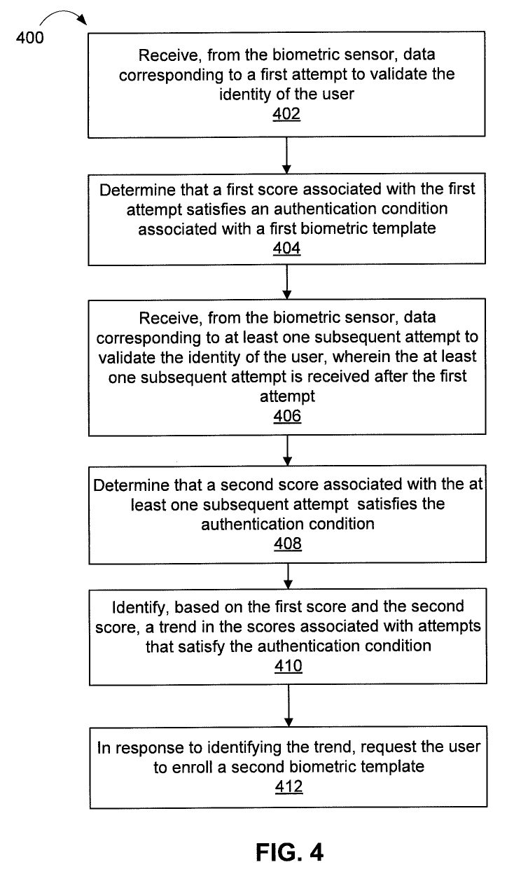

FIG. 4 is a flow diagram of method steps for authenticating a user, according to one embodiment of the disclosure. As shown, the method 400 begins at step 402, where a processing system receives, from a biometric sensor, data corresponding to a first attempt to validate the identity of the user. In one implementation, the processing system comprises processing system 104 in FIG. 1. Although the method 400 is described in the context of biometric authentication (for example, fingerprint authentication) other embodiments may not involve biometrics and can be used in any authentication scheme in which authentication can be successful even if the authentication attempt does not perfectly match a template.

According to various embodiments, the biometric sensor may be a fingerprint sensor or a sensor (such as a camera) configured to perform facial or other physical recognition. In other embodiments, the biometric sensor may be configured to accept gestures, such that the user is requested to perform a gesture to authenticate.

In one embodiment, the processing system is configured to enroll the first biometric template prior to receiving the data corresponding to the first attempt to validate the identity of the user (not shown in FIG. 4).

At step 404, the processing system determines that a first score associated with the first attempt satisfies an authentication condition associated with the first biometric template. For example, each authentication attempt may be assigned a score representing how closely the authentication attempt matches to a template. In one example, the authentication condition may be a threshold value. In one embodiment, determining whether the first score associated with the first attempt satisfies an authentication condition comprises computing a numerical value corresponding to the first score and comparing the numerical value to a threshold value. If the score satisfies a threshold value, then the authentication attempt is successful. If the score does not satisfy the threshold value, then the authentication attempt is not successful. In some embodiments, additional criteria may be considered before determining whether an authentication is successful, e.g., other biometrics or other authentication factors.

At step 406, the processing system receives, from the biometric sensor, data corresponding to at least one subsequent attempt to validate the identity of the user, wherein the at least one subsequent attempt is received after the first attempt. At step 408, the processing system determines that a second score associated with the at least one subsequent attempt satisfies the authentication condition. In one embodiment, steps 402/406 are similar to steps 404/408, respectively, but for different attempts.

In one embodiment, determining that a score satisfies the authentication condition (i.e., steps 404, 408) comprises unlocking a device such as a mobile phone.

At step 410, the processing system identifies, based on the first score and the second score, a trend in the scores associated with attempts that satisfy the authentication condition. In one embodiment, the trend is associated with a decrease over time in the scores associated with attempts that satisfy the authentication condition. As described, the trend may be represented by a trend line.

In one embodiment, if the trend line has decreasing slope, then template aging may be occurring. In one embodiment, if the trend line has decreasing slope that is below a slope threshold, then template aging may be occurring.

In still further embodiments, different models can be used to detect template aging. One example is a “linear model,” represented by the equation:

s(t)=α*t+β.

where s(t) is the score at time t, and the parameters of the model, α and β, are the change in score per unit time and the overall score offset, respectively. The linear model assumes a linear decay or growth (i.e., α negative or positive) as a function of time. The linear model can be used to predict the score at a future time t′ by simply evaluating s(t′). The parameters of the linear model can be estimated from a moving window of historical scores, such as s(t−w), s(t−w+1), s(t−w+2), . . . , s(t−1).

Another model used to detect template aging is a “dynamic model,” represented by the equations:

xₜ=Axₜ₋₁+vₜ,

s(t)=Bxₜ+wₜ,

where xₜ is an internal state at time t, vₜ and wₜ are noise variables, and A and B are the system dynamics and measurement model, respectively. The dynamical model may represent a Kalman Filter that tracks the score over time. The dynamic model may model the score as a moving particle with some internal velocity (i.e., decay or growth). The internal state can be updated recursively over time and the dynamic model can be used to predict the future value of the score.

In still further embodiments, more sophisticated models, such as those with cyclical trends, could also be used to detect template aging.

At step 412, in response to identifying the trend, the processing system requests the user to enroll a second biometric template. In one embodiment, the second biometric template replaces the first biometric template so that the authentication condition is associated with the second biometric template. In another embodiment, the second biometric template is stored in addition to storing the first biometric template, such that the authentication condition is associated with both the first biometric template and the second biometric template. In yet another embodiment, the second biometric template comprises an update to the first biometric template.

Advantageously, embodiments of the disclosure provide a system and method that may detect that, although the user has been consistently able to authenticate, the authentication scores are decreasing. Thus, the user may be asked to re-enroll a new template before the scores decrease to the point where more authentication attempts will fail on a consistent basis, which makes the disclosed system easier to use and less frustrating for the user.

The embodiments and examples set forth herein were presented in order to best explain the present disclosure and its particular application and to thereby enable those skilled in the art to make and use the invention. However, those skilled in the art will recognize that the foregoing description and examples have been presented for the purposes of illustration and example only. The description as set forth is not intended to be exhaustive or to limit the invention to the precise form disclosed.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and “at least one” and similar referents in the context of describing the invention (especially in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A device for biometric authentication, comprising:
a biometric sensor; and
a processing system configured to:
receive, from the biometric sensor, data corresponding to a first attempt to validate an identity of a user;
determine that a first score associated with the first attempt satisfies an authentication condition associated with a first biometric template;
receive, from the biometric sensor, data corresponding to at least one subsequent attempt to validate the identity of the user, wherein the at least one subsequent attempt is received after the first attempt;
determine that a second score associated with the at least one subsequent attempt satisfies the authentication condition;
identify, based on the first score and the second score, a trend in the scores associated with attempts that satisfy the authentication condition; and
in response to identifying the trend, request the user to enroll a second biometric template.

2. The device of claim 1, wherein the second biometric template replaces the first biometric template so that the authentication condition is associated with the second biometric template.

3. The device of claim 1, wherein the second biometric template is stored in addition to storing the first biometric template, such that the authentication condition is associated with both the first biometric template and the second biometric template.

4. The device of claim 1, wherein enrolling the second biometric template comprises updating the first biometric template to an updated biometric template.

5. The device of claim 1, wherein the trend is associated with a decrease over time in the scores associated with attempts that satisfy the authentication condition.

6. The device of claim 1, wherein the trend is associated with a linear trend line with a negative slope.

7. The device of claim 1, wherein the trend is associated with a time series model and decreasing scores relative to the authentication condition.

8. The device of claim 1, wherein the processing system is configured to enroll the first biometric template prior to receiving the data corresponding to the first attempt to validate the identity of the user.

9. The device of claim 1, wherein determining that the first score satisfies the authentication condition comprises unlocking the device.

10. The device of claim 9, wherein unlocking the device is further based on at least one additional authentication criterion besides the first score.

11. The device of claim 1, wherein the biometric sensor comprises a fingerprint sensor.

12. The device of claim 11, wherein the first biometric template comprises a template of a fingerprint of the user captured using the fingerprint sensor.

13. The device of claim 1, wherein the biometric sensor comprises a sensor configured to perform facial recognition.

14. The device of claim 1, wherein the biometric sensor is configured to capture behavioral information corresponding to the user.

15. The device of claim 1, wherein determining that the first score associated with the first attempt satisfies an authentication condition comprises:
computing a numerical value corresponding to the first score; and
determining that the numerical value satisfies a threshold value.

16. A method for biometric authentication, comprising:
receiving, from a biometric sensor, data corresponding to a first attempt to validate an identity of a user;
determining that a first score associated with the first attempt satisfies an authentication condition associated with a first biometric template;
receiving, from the biometric sensor, data corresponding to at least one subsequent attempt to validate the identity of the user, wherein the at least one subsequent attempt is received after the first attempt;
determining that a second score associated with the at least one subsequent attempt satisfies the authentication condition;
identifying, based on the first score and the second score, a trend in the scores associated with attempts that satisfy the authentication condition; and
in response to identifying the trend, requesting the user to enroll a second biometric template.

17. The method of claim 16, wherein the trend is associated with a decrease over time in the scores associated with attempts that satisfy the authentication condition.

18. The method of claim 16, wherein the trend is associated with a linear trend line with a negative slope.

19. The method of claim 16, wherein determining that the first score associated with the first attempt satisfies an authentication condition comprises:
computing a numerical value corresponding to the first score; and
determining that the numerical value satisfies a threshold value.

20. A non-transitory computer-readable storage medium storing instructions that, when executed by a processor, causes a computing device to authenticate a user, by performing steps comprising:
receiving, from a biometric sensor, data corresponding to a first attempt to validate an identity of the user;
determining that a first score associated with the first attempt satisfies an authentication condition associated with a first biometric template;
receiving, from the biometric sensor, data corresponding to at least one subsequent attempt to validate the identity of the user, wherein the at least one subsequent attempt is received after the first attempt;
determining that a second score associated with the at least one subsequent attempt satisfies the authentication condition;
identifying, based on the first score and the second score, a trend in the scores associated with attempts that satisfy the authentication condition; and
in response to identifying the trend, requesting the user to enroll a second biometric template.

21. The computer-readable storage medium of claim 20, wherein the trend is associated with a decrease over time in the scores associated with attempts that satisfy the authentication condition.

22. The computer-readable storage medium of claim 20, wherein the trend is associated with a linear trend line with a negative slope.

23. The computer-readable storage medium of claim 20, wherein determining that the first score associated with the first attempt satisfies an authentication condition comprises:
computing a numerical value corresponding to the first score; and
determining that the numerical value satisfies a threshold value.
